(19) United States
(12) Patent Application Publication
(10) Pub. No.: US 2002/0059138 A1
(43) Pub. Date: May 16, 2002

(54) Message exchange server allowing enhanced message charge allocation, and method

(75) Inventors: Craig Priest, Etobicoke (CA); Grant Hood, Etobicoke (CA)

Correspondence Address: DOWELL & DOWELL PC, SUITE 309, 1215 JEFFERSON DAVIS HIGHWAY, ARLINGTON, VA, 22202

(73) Assignee: FIRST MEDIA GROUP INC.

(21) Appl. No.: 09/987,040

(22) Filed: Nov. 13, 2001

Related U.S. Application Data
(60) Provisional application No. 60/247,357, filed on Nov. 13, 2000.

(51) Int. Cl. G06F 17/60

(52) U.S. Cl. 705/39

(57) ABSTRACT

A message exchange server, method and software are disclosed. An exemplary exchange server allows a plurality of users to communicate with each other is operated so that paying users may communicate with all of the plurality of users using the device and non-paying users are restricted from communicating with other non-paying users. Example embodiments prevent non-paying users from hearing personal greetings of other non-paying users; non-paying users may from sending messages to non-paying users; or non-paying users may from bridging telephone calls with other non-paying users. Corresponding paying users, on the other hand, may hear all personal greetings; send messages to all users; bridge calls with all users. Additionally the server may allow a charge associated with sending a message from a message originator to a recipient at a message exchange server to be allocated based on an indicator received from the message originator. This indicator indicates whether the charge is to be borne by the originator or by the recipient. If the charge is to be borne by the recipient, the recipient may later agree to assume the charge and hear the message, or decline the charge without hearing the message.

### CROSS-REFERENCE TO RELATED APPLICATIONS

This application claims benefits from U.S. provisional patent application no. 60/247,357 filed Nov. 13, 2000, the contents of which are hereby incorporated by reference.

### FIELD OF THE INVENTION

The present invention relates to personal introduction and message exchange services, such as dating services, and more particularly to methods and devices for allocating charges for using such services.

### BACKGROUND OF THE INVENTION

Over the past several years, personal message exchange services, such as computer and telephone based dating and introduction services have become increasingly popular. These services offer users a convenient and time-efficient way to contact, and eventually meet others for romantic or social purposes.

Typically, users of such services can access a main server operated by a service provider, usually by using a telephone or a computer terminal. By way of such access, each user can browse a pool of personal greetings and personal information left by others; create his or her own personal greeting and personal information profile; check his or her personal mailbox for messages sent by others; and send personal messages to the mailboxes of others.

Alternatively, or additionally, users may join conferences between two or more other users. The conferences may be by way of conference calls, or by way of computer network chat groups or rooms. As such, such conferences are often colloquially referred to as “chat rooms”. Advantageously, chat-rooms enable users to communicate with others on an anonymous basis. Furthermore, chat rooms make the initial contact between users less socially awkward and intimidating than if the users were to employ more conventional means, such as making direct telephone calls or even leaving messages.

Often access to a particular service is provided by telephone. A user accessing a server hosting the service is usually directed through a series of voice menus to the pool of stored personal greetings. The user need not browse all the greetings in the pool but may browse only those greetings left by users that match the user's personal preferences. For example, a male user wishing to meet females of a particular age range and who live in a certain geographic locale, may be able to browse only those personal greetings left by females meeting these criteria. Typically, the user will listen to the personal greetings and may originate a message to the mailbox of recipients that the caller might be interested in meeting. At some later time, a recipient may access an associated personal mailbox, check received messages, and decide whether to respond to those messages. Where the recipient responds to a message by sending another message to the message originator, the two may start an exchange that may ultimately lead to a face-to-face meeting, and possibly to a relationship.

Personal introduction and message exchange services typically generate revenues for service providers in one of two ways: by charging periodic subscription fees, or by charging users for actual use of the service.

Disadvantageously for users, periodic subscription fees must typically be paid regardless of the effectiveness of the service. Thus, subscribers may join a service only to later discover that not enough users meeting the subscriber's preferences use the same service. Consequently, this subscriber may have difficulties meeting others despite having paid for the service. Accordingly, users may be reluctant to pay on-going subscription fees for a personal exchange service.

By charging users for actual use of the service, charges may only be levied once a user believes the service to provide value. For example, a user may be charged only while contacting others. Thus, users could be allowed access to the pool of personal greetings and users' information free of charge. Similarly, they may place personal greetings free of charge. Use-based charges may be pre-paid or billed once incurred.

These use-based charges may be perceived as somewhat fairer by users than subscription fees, as users may determine, without any costs, if others of interest use the service. Conveniently, when users suspend their use of the service, they incur no further charges. Moreover, advantageously, users are encouraged to place personal greetings without incurring charges.

For telephone based services, use based charges may easily be levied by tracking the time spent recording messages for others or listening to messages in a mailbox.

Disadvantageously, by charging for actual message exchange services, users may be charged for both sending messages and for checking received messages. In some cases, users may consider this to be unfair, and may therefore be reluctant to send messages or check received messages. For example, a popular recipient who is ordinarily charged for listening to received messages might consider it unfair to have to pay to listen to messages sent by others interested in contacting that recipient. Additionally, the recipient may wish to respond to some messages without assuming the associated cost. Under these circumstances, the recipient may think that it would be more appropriate for the message originators to bear both the costs of the messages sent by those message originators, and the costs of the response. Similarly, in view of the associated costs, a user may be reluctant to send messages to a large number of recipients, without knowing how many of these may be interested in further contact.

Similarly, conference/chat room users not familiar with a particular conference can only determine the conference's effectiveness for meeting others and learn of the service's benefits by trying out the service for themselves. This necessarily means that those new users would have to incur a certain level of expense before finding out if a particular chat room service meets their needs. There may therefore be reluctance on the part of new users to join a conference service they know very little about, and for which they will be immediately charged as soon as they start using the service.

The service provider, on the other hand, is similarly reluctant to allow users to use the service free of charge without receiving some benefit.

It would, therefore, be desirable to give users greater flexibility and options in incurring charges for sending and receiving messages.

### SUMMARY OF THE INVENTION

It is therefore an object of the present invention to provide message originators using a personal message service with the option of transferring costs associated with originating messages to recipients. It is a further object of this invention to inform recipients that a received message has not been paid for, and to further allow the recipients to accept the charge and check the message, or refuse the charge, thereby declining to check the message.

In accordance with an aspect of the present invention, a charge associated with sending a message from a message originator to a recipient at a message exchange server is allocated based on an indicator received from the message originator indicating whether the charge is to be borne by the originator or by the recipient. If the charge is to be borne by the recipient, the recipient may later agree to assume the charge and hear the message, or decline the charge without hearing the message.

In accordance with another aspect of the present invention, a device that allows a plurality of users to communicate with each other is operated so that paying users may communicate with all of the plurality of users using the device and non-paying users are restricted from communicating with other non-paying users. For example, in accordance with aspects of the invention, non-paying users may be restricted from hearing personal greetings of other non-paying users; non-paying users may be restricted from sending messages to non-paying users; or non-paying users may be preventing from bridging telephone calls with other non-paying users. Paying users, on the other hand, may hear all personal greetings; send messages to all users; bridge calls with all users.

The invention may be embodied in a suitably adapted message exchange device or software stored on a computer readable medium.

Other aspects and features of the present invention will become apparent to those of ordinary skill in the art, upon review of the following description of specific embodiments of the invention in conjunction with the accompanying figures.

### BRIEF DESCRIPTION OF THE DRAWINGS

In figures which illustrate, by way of example, embodiments of the present invention,

FIG. 1 is a simplified block diagram telephone sets in communication with a message exchange and conference server, exemplary of an embodiment of the present invention;

FIG. 2A illustrates an example greeting record forming part of the greeting database hosted by the message exchange server of FIG. 1;

FIG. 2B illustrates an example directory structure at the message exchange server of FIG. 1;

2C illustrates the format of a control information file used in association with messages stored in the directory structure of FIG. 2B;

FIG. 2D illustrates an example administrative record forming part of the accounts database hosted by the message exchange server of FIG. 1;

FIG. 3 is a simplified block diagram of a portion of the message exchange server of FIG. 1;

FIG. 4 is a flow chart illustrating steps performed by the server of FIG. 1, presenting a user with a main menu;

FIG. 5 is a flow chart illustrating steps performed at the server of FIG. 1, allowing users to browse stored greetings;

FIG. 6 is a flow chart illustrating exemplary steps performed by the server of FIG. 1 in response to a message originator sending a message;

FIG. 7 is a flow chart illustrating exemplary steps performed by the server of FIG. 1 in response to a message recipient receiving messages; and

FIG. 8-13 are flow charts illustrating exemplary steps performed by the server of FIG. 1 to allow users to access a chat room service hosted by the server of FIG. 1, in manners exemplary of the present invention.

### DETAILED DESCRIPTION

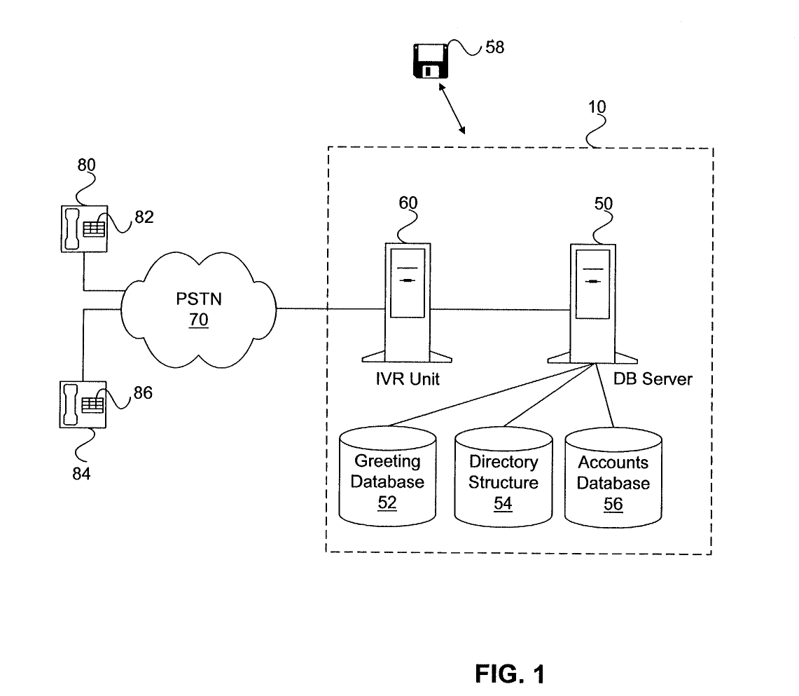

FIG.1 illustrates an apparatus facilitating the exchange of messages in the form of a personal message exchange server 10, exemplary of an embodiment of the present invention. Server 10 includes an Interactive Voice Response (“IVR”) unit 60, in communication with a database server 50.

Database server 50 and IVR unit 60 may be interconnected by way of a conventional computer network, which is preferably a local area network (“LAN”).

IVR unit 60 may further include a telephone network interface interconnecting server 10 with a telephone communications network, that is preferably the public switched telephone network (PSTN) 70. As will become apparent, IVR unit 60 allows users to access server 10 by way of PSTN 70. Conveniently, a plurality of users may simultaneously communicate with IVR 60, and with each other, by way of PSTN 70 as detailed below. Example user telephones 80 and 84, interconnected with PSTN 70 are further illustrated. Users of server 10 can communicate instructions and enter information by pressing touchpad 82 on telephone 80, or touchpad 86 on telephone 84. For the sake of clarity, only two telephones are illustrated. Of course, server 10 may in theory be accessed by any other telephone in communication with PSTN 70.

Database server 50 is preferably a conventional network aware computing device. Database server 50 therefore includes a conventional processor in communication with computer memory and a network interface. As such, server 50 stores and executes a conventional network aware operating system such as a Microsoft Windows NT operating system, a Unix operating system, or the like. As well, database server 50 includes a conventional file system, preferably controlled and administered by the operating system governing overall operation of server 50. This file system preferably hosts a greeting database 52 and an accounts database 56. As will become apparent, server 50 provides information contained in these databases to requesting computing devices. If needed, other databases may of course be hosted by server 50. Software programs to process requests made by interconnected computing devices may be stored in persistent storage memory, such as a harddisk drive, for execution by server 50. Similarly, software adapting server 50 to perform in manners exemplary of the present invention, including the operating system, is preferably also stored within persistent storage memory at server 50. These and other software applications can be loaded into persistent storage memory of 50 from computer readable media 58 such as a CD-ROM, diskette, tape, or the like.

The file system of server 50 further includes a directory structure 54 formed within the hosted file system. The directory structure 54 may for example be a logical drive in the file system recognised by the operating system controlling server 50. As such, directory structure 54 includes a collection of logically associated directories and files.

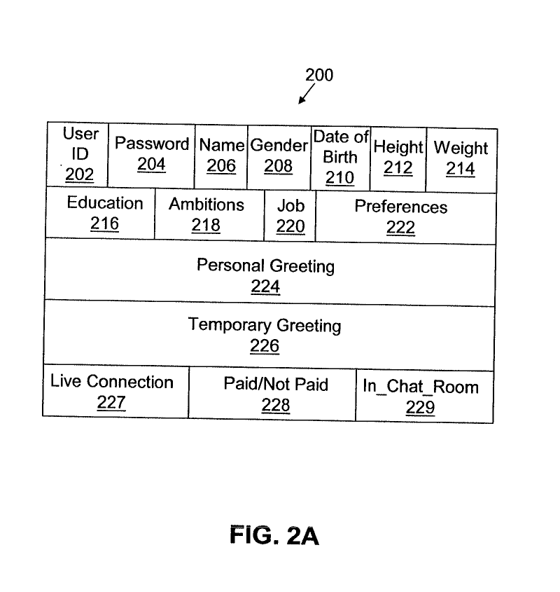

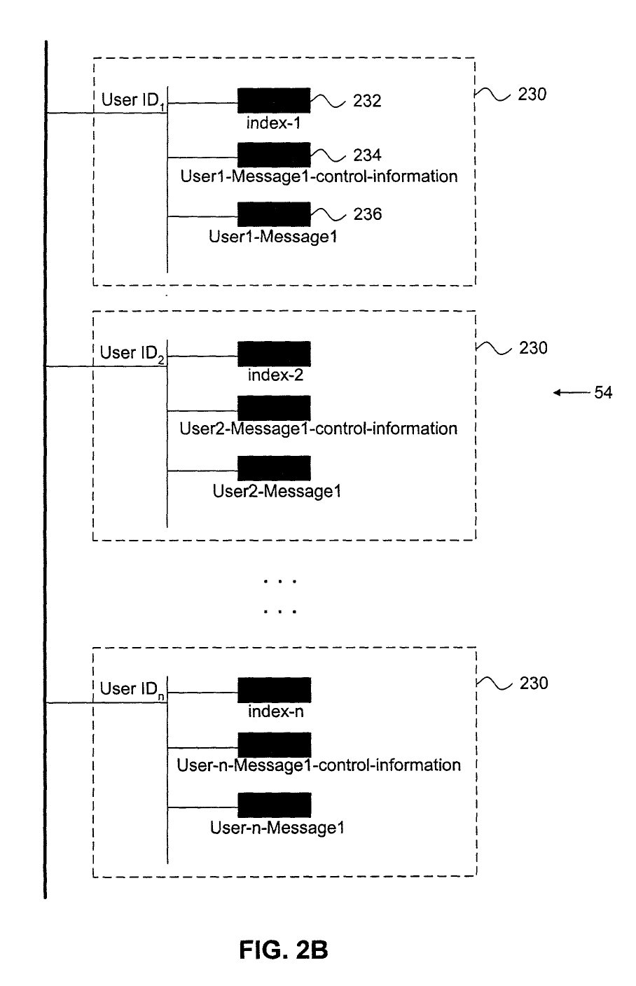

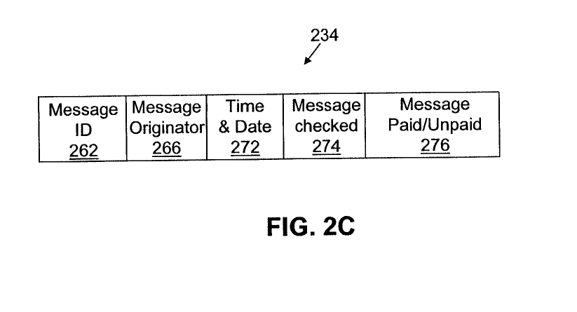

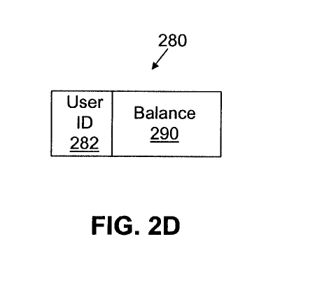

Example record and file/directory structures of databases 52 and 56, and directory structure 54 are more particularly illustrated in FIGS. 2A, 2B, 2C, and 2D. FIG. 2A illustrates an example greeting record forming part of the greeting database 52 hosted by message exchange server 10 of FIG. 1; FIG. 2B illustrates an example embodiment of a directory structure 54, hosted by message exchange server 10 where users' messages are stored; FIG. 2C illustrates the format of a control information file used in association with messages stored in the directory structure 54 of FIG. 2B; and FIG. 2D illustrates an example administrative record forming part of the accounts database hosted by message exchange server 10.

Greeting database 52 preferably includes a plurality of greeting records each corresponding to a known user of message exchange server 10. An example greeting record 200 is illustrated in FIG. 2A. Server 50 preferably enables users to browse the greeting database in order to learn more about other users and to determine which of those other users meet their preferences. Each record includes several fields relevant to a particular user. Specifically, record 200 preferably includes a user ID field 202 that contains a unique identification number that allows server 50 to easily index and access record 200. Record 200 preferably also contains password field 204 containing a password that is preferably known only to the user associated with record 200. Optionally, a name field 206 contains a name or nickname of the user. Additionally, record 200 includes several fields containing personal attributes of an associated user including gender field 208 detailing the user's gender; date of birth field 210 detailing the user's date of birth; height field 212, and weight field 214, detailing the user's height and weight, respectively; education field 216 providing information about the user's educational background; ambition field 218 listing the user's ambitions; job field 220 describing the user's occupation; and preferences field 222 containing information about the characteristics of others that the particular user is seeking to meet. Data within these fields may be stored in ASCII, as bitmaps or in other suitable formats. Record 200 further includes personal greeting field 224 and temporary greeting field 226 which contain personal greetings stored in a computer readable format prepared by the user associated with record 200 for use by IVR unit 60. Personal greeting field 224 may be either a pre-recorded greeting in a suitable sound data format such as those formats dictated by G.711, G.726 or the like. Temporary greeting field 226 similarly stores a pre-recorded greeting in a suitable sound data format, for use in establishing live conferences, or “chat” sessions between users, as detailed below. Additionally, a “chat” payment status field 228 is included in record 200. Field 228 preferably contains an indicator of a user's desire to pay for using chat room services offered at server 10. Field 229 further stores an indicator, indicative of whether or not a user is currently taking part in a chat. Field 227 stores an indicator, indicative of whether or not a user is currently taking part in a one-on-one conversation with another user, bridged at server 10.

Directory structure 54 preferably stores personal messages received for users, sent by others, and thereby acts as a user's mailbox. An example embodiment of directory structure 54 is shown in FIG. 2B. As illustrated, directory structure 54 is divided into user directories with each directory storing files associated with messages received by a particular user. User directories in directory structure 54 are preferably identified by the unique UserID stored in field 202. Thus, the illustrated directory corresponds to a user associated with a UserID1 (also stored in fields 202 of record 200 of that user). Other illustrated directories are associated with UserID2 and UserID3. Each directory preferably indexes several files associated with an identified user. Specifically, each directory 230 contains an index file 232 containing information that server 50 uses to perform mailbox management and maintenance. Index file 232 preferably includes password of the user associated with directory 230 to ensure that only the user who enters the password stored in file 232 is granted access to files within directory 230. For security purposes, the password stored in file 232 may be encrypted in ways familiar to those of ordinary skill. File 232 may also include the name of the user associated with directory 230, and the number of new unchecked messages that have been received at directory 230 since the last time the user checked for new messages. It will be appreciated that additional information may also be stored in file 232.

Every message stored within directory 230 preferably includes two associated files. A first file 234 storing control information associated with a message and a second file 236 storing data representative of the actual received message. The format of example control information stored in file 234 is illustrated in FIG. 2C. As illustrated the control information preferably includes a unique message identifier in field 262; the userID of the message originator in field 266; the time and date of receipt of the message in field 272; a flag indicating whether the message has been checked (i.e. listened to, or the like) by the recipient in field 274; and a flag indicating whether the message has been paid for or not in field 276. As will become apparent, the flag contained in field 276 is used by server 50 to determine if a received message has already been paid for by the message originator, or whether the cost of the message is to be borne by the message recipient. The message file 236 may contain a voice message encoded using a suitable CODEC.

Accounts database 56 (FIG. 1) preferably stores administrative data for known users. Database 56 preferably contains a plurality of administrative, records each associated with a known user of message exchange server 10. An example administrative record 280 is illustrated in FIG. 2D. As illustrated, each record 280 includes several fields that contain administrative information about a particular user. Specifically, record 280 preferably includes a UserID field 282 containing the same unique identifier stored in field 202 of record 200 (FIG. 2A), and identifying a directory in structure 54, allowing server 50 to easily access and index record 280.

Charges accrued by the user for using message exchange server 10 may be accounted for in balance field 290. Balance field 290 preferably stores an indicator of a pre-paid amount, less any accrued charges charged to the user. Accrued charges may be subtracted from balance field 290, as these are accrued.

Those versed in the art will appreciate that many other possible fields may be included in records 200 and 280. Further, it will be appreciated that the fields included in records 200 and 280 may be structured in many ways, and that the records in databases 52 and 56 can themselves be organized in many different ways. Databases 52 and 56 are preferably stored on an alterable storage medium, such as a hard-drive, which may form part of server 50. Database 52 and 56 are managed and maintained by server 50 which may further store and execute database management software applications such as FOX Pro, Dbase, or other suitable software designed to manage and maintain the information stored within databases 52 and 56. Directory structure 54 could easily be replaced with a suitably formed database. Messages for users could be suitably stored and indexed in the database for later retrieval. Records 234 (FIG. 2B) for all users could be combined and stored within a separate database, allowing for the quick indexing and manipulating of message files 236.

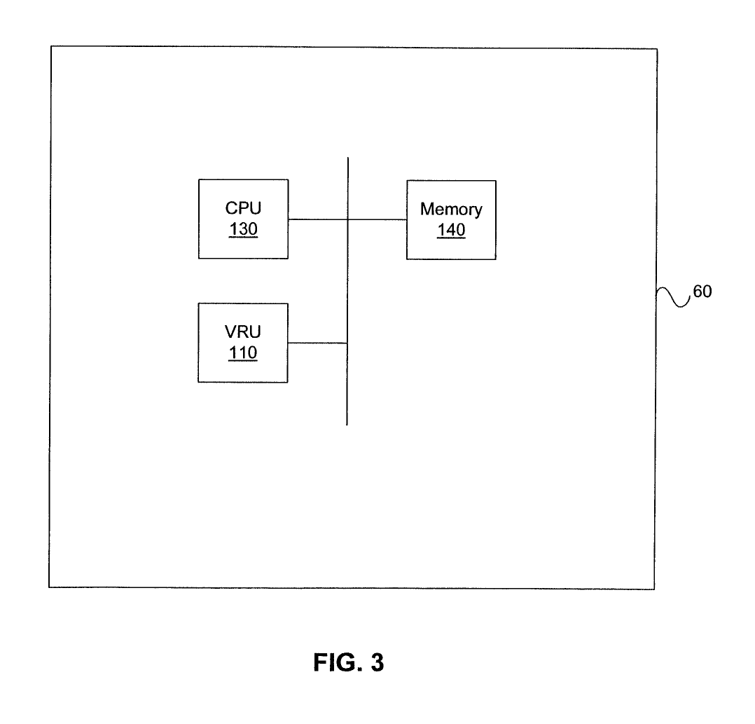

FIG. 3 illustrates an exemplary embodiment of IVR unit 60. IVR unit 60 is preferably a conventional computing device which stores and executes suitable software to act as an interactive voice response processor. As such, unit 60 includes CPU 130 such as an Intel Pentium™ class CPU, and memory 140 including Random Access Memory (RAM) and persistent storage memory. Memory 140 stores computer programs executed by CPU 130, including the voice response program used to prompt users for requisite information, and for storing voice response segments in a computer readable sound format formed by a suitable CODEC. These voice response segments are used to provide verbal information to users accessing message exchange server 10 through a telephone, and to prompt those users to make selections and enter data. These voice response segments can be converted into speech signals compatible with PSTN 70. Again, software and voice response segments stored within memory 140 may be loaded into memory 140 from computer readable medium (not illustrated) which may be CD-ROM, diskette, tape, hard-drive, or the like.

IVR unit 60 preferably also includes a voice response unit (VRU) 110 such as Dialogic D4100ESC or D240SC-TI IVR card, to provide the physical connection between unit 60 and PSTN 70. Preferably IVR unit 60 includes several such VRUs (only one is illustrated). In the example embodiment, each VRU 110 may provide up to 300 users simultaneous access to IVR unit 60.

VRU 110 preferably also includes a Dual Tone Modulated Frequency (DTMF) logger. This logger decodes DTMF tones corresponding to number keys on a telephone touchpad such as touchpad 82 or 86. Once a communication link between unit 60 and telephone 80 or 84 has been established, VRU 110 receives DTMF signals corresponding to a user's instructions and information. VRU 110 converts these DTMF signals into computer readable format, and preferably forwards these to CPU 130, or to some other module, for further processing.

VRU 110 preferably also includes an analog to digital (A/D) and digital to analog (D/A) converters. The A/D converter may convert speech segments articulated by a user, like a personal greeting, or a voice message, into a digital speech signal that can thereafter be converted into a computer readable sound format using a suitable CODEC. Converted speech segments can then be stored in either database 52 or as a file in directory structure 54. Similarly, the D/A converter may convert voice or speech data received from either memory 140, or from databases 52 and files within directory structure 54, into speech signals. These speech signals may then transmitted from VRU 110 to a recipient in communication with PSTN 70.

Those versed in the art will appreciate that VRU 110 may include storage space in the form of PROM chips, CD-ROM, hard-drive, or some other suitable medium, to hold a repository of common voice response segments in a suitable computer readable sound data format that can readily be converted into speech signals. These voice response segments may then be synthesized into speech signals and transmitted onto PSTN 70. For example, when an incoming call arrives, VRU 110 may retrieve from its resident storage a voice response segment that corresponds to a standard greeting that is played to all users. That segment may be converted into a speech signal, and transmitted to a user at telephones 80 or 84 through PSTN 70.

In operation, a user wishing to use server 10 (FIG. 1) preferably first registers. An example user may access message exchange server 10 using telephone 80 or 84 by dialing a telephone access number associated with message exchange server 10. The user may thus establish a communications link with unit 60 by way of PSTN 70. In order to register, a user typically enters a previously assigned identifier by way of his or her touchpad. In the event the user has not previously registered and has not yet obtained an identifier/password unit 60 may initiate a registration sequence. Preferably this registration sequence will prompt the user to enter personal information by sending proper voice response segments stored in memory 140 to telephone 80 or 84 prompting the user to enter his/her name and address, age, as detailed above. A user may enter requested information by pressing the appropriate keys on touchpad 82 or 86. The information keyed in by the caller is sent to unit 60 in the form of DTMF signals. VRU 110 (FIG. 3) converts the DTMF signals corresponding to the user's selections into computer data that can be processed by CPU 130 and provided to server 50. The information received from the user is then forwarded to server 50 allowing server 50 to create user records 200 and 260 and directory 230 for the user. At this point the user may be assigned or choose a password or personal identification number that may be used to access the created account. Alternatively, server 60 may transfer the user to a call center (not illustrated). There, an operator may personally query the user to obtain details that may be provided to server 60 to populate fields of record 200. Optionally personal information need not be solicited or provided to server 10, allowing users anonymous use of server 10. Once registered, the user may also record a personal greeting. Greetings may be screened by an operator of server 10 before being recorded to ensure they do not contain offensive content. The recorded greeting is stored in field 224 in the user record 200.

As should now be apparent, each user may store a personal greeting. The collection of personal greetings of the various users forming a pool of personal greetings within database 52. This pool may be browsed by a user so that the user may locate greetings of interest. Once a suitable greeting is located, a browsing user may send a message to a user associated with the located greeting.

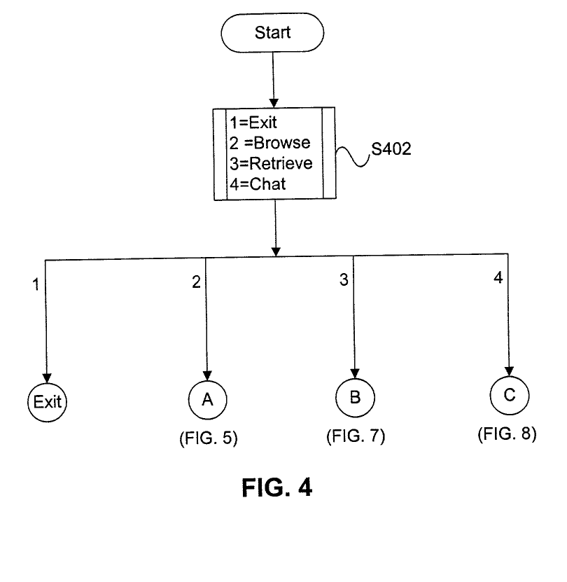

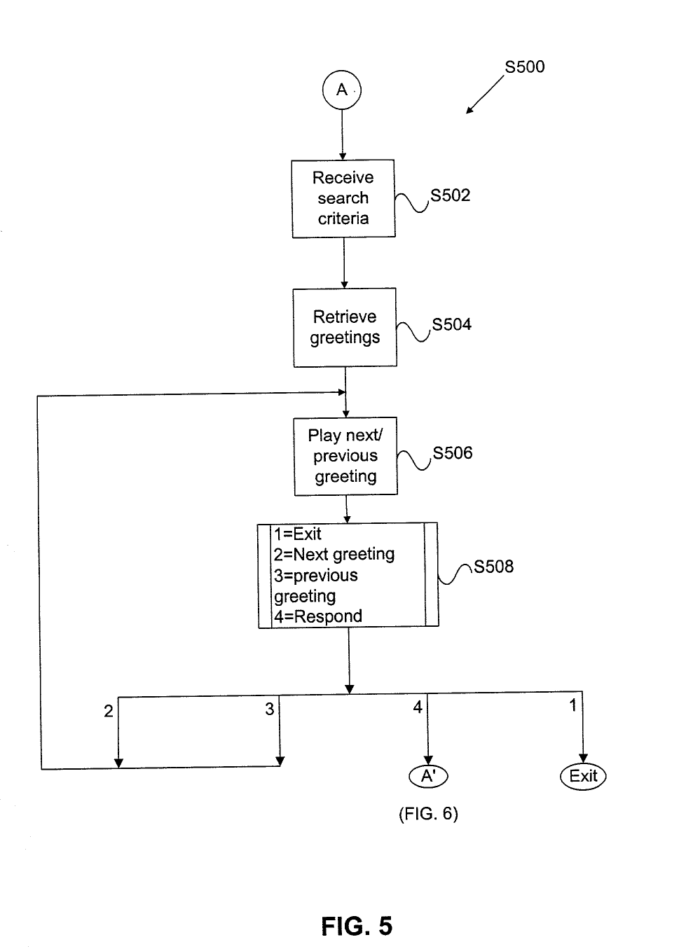

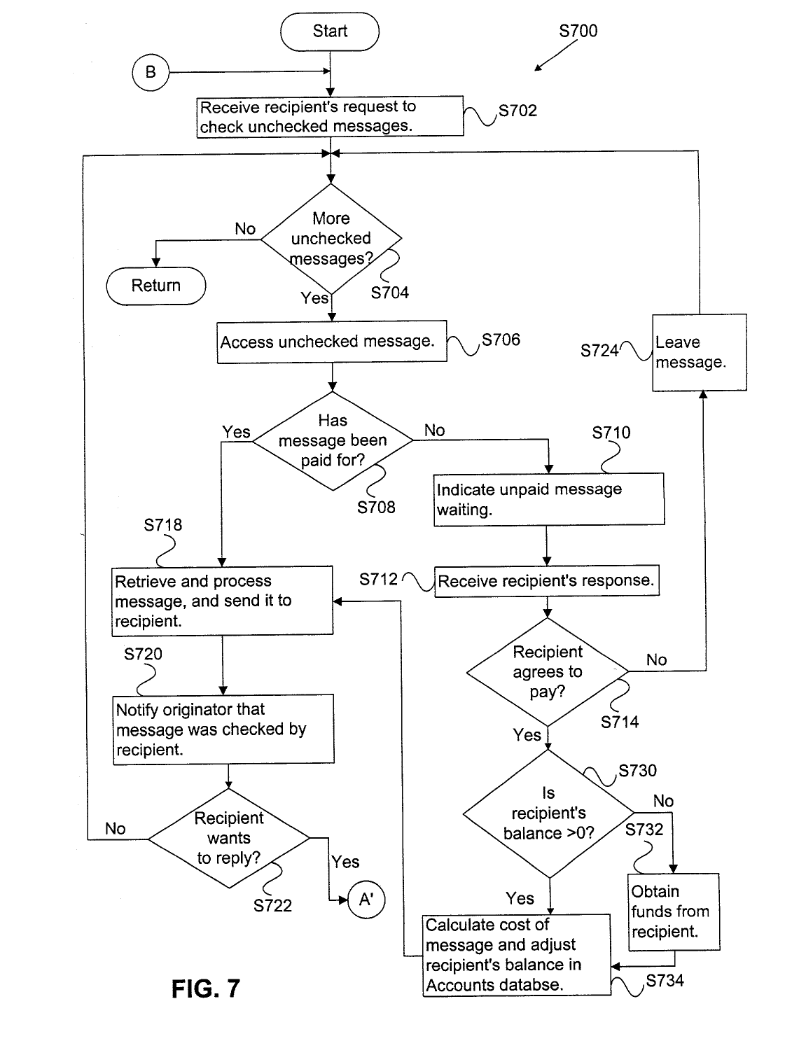

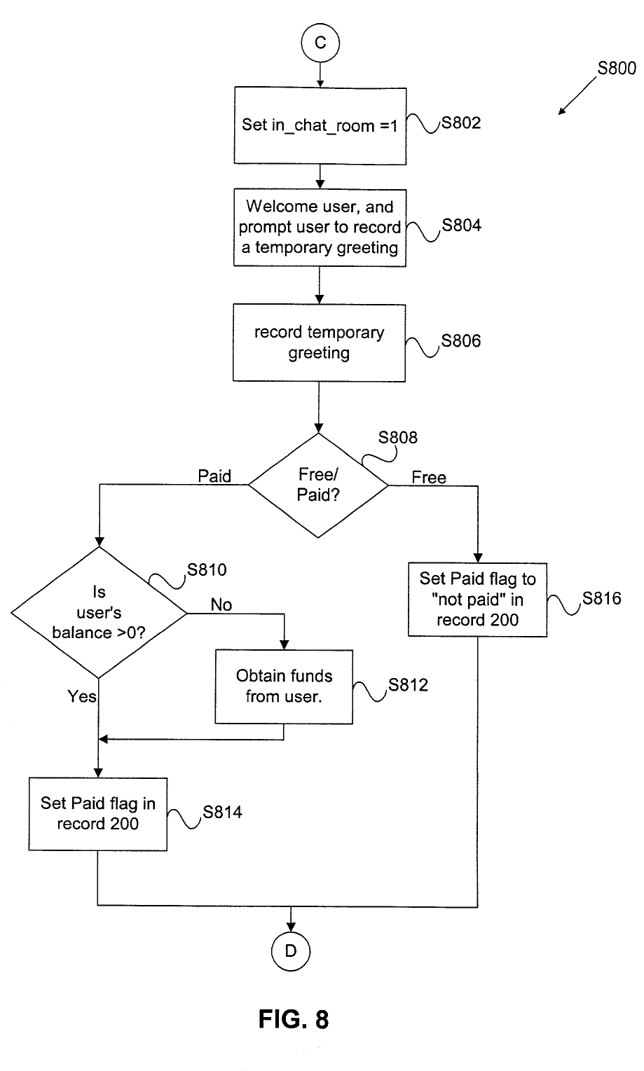

So, after a user has logged on to server 10 for the first or subsequent time and has recorded a personal greeting, the user is next given a series of options. Specifically, the user is given the option of exiting; browsing personal greetings of others stored in database 52; retrieving messages left for the user by others; or joining an in-session conference or chat, as more particularly illustrated in FIG. 4. Decisions may be communicated by way of DTMF tones received in step S402. Specifically, in step S402 the user is prompted to exit; browse; retrieve waiting messages; or join a conference/chat. If a user wishes to exit, as determined in step S402, he/she is allowed exit. In the event a user wishes to browse greetings of others, steps S500 (FIG. 5) and onward are performed. In the event a user wishes to join a chat, as determined in step S402, steps S800 and onward (FIGS. 8-13), detailed below are performed. In the event the user wishes to retrieve messages sent by others, steps S700 (FIG. 7) are performed.

If the user wishes to browse stored greetings of others as determined in step S402, a user may browse greeting database 52 by pressing appropriate keys on touchpad 82 or 86 to indicate to server 10 to browse the personal greetings. The user may, in response to prompting from unit 60, make touchpad selections to further narrow the search of database 52 that is to be performed by server 50 in step S502, as illustrated in FIG. 5. For example, the user may press a key corresponding to the user gender preference, press another key corresponding to the user's age-range preferences, and so on. In response to the user's request to browse the greetings, unit 60 sends a request to server 50 to access greeting database 52 and retrieve the personal greetings corresponding to the user's request in step S504. The retrieved greetings are provided to unit 60 and VRU 110 that converts the personal greetings into speech signals that are provided to PSTN 70. Users at telephones 80 and 84 can then listen to the retrieved greetings. Greetings may be sequentially presented in step S506, as controlled by appropriate DTMF inputs provided in step S508. A user is, of course also given the option to exit between greetings in step S508.

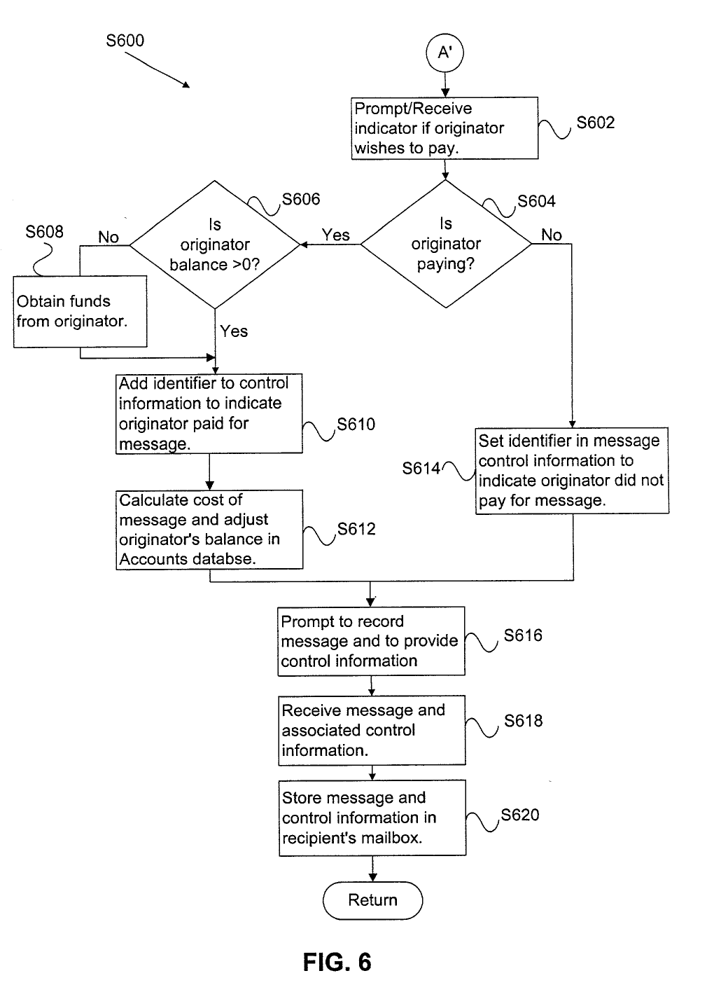

Once a user has reviewed personal greetings of others, the user—acting as a message originator—using example telephone 80, may wish to send a message to another user as determined in step S508. Steps performed at message exchange server 10 to allow a user to send a personal message, exemplary of an embodiment of the present invention are more particularly illustrated in FIG. 6.

As illustrated, once a recipient is identified as a result of browsing, and the originator has indicated that he or she wishes to send a message to that recipient, server 10 prompts the originator to indicate who is to pay for the message and receives a corresponding indicator in step S602. Specifically, VRU 110 preferably transmits to the originator at telephone 80 a prompt requesting the originator to indicate whether it is the originator or the recipient who is to pay for the message. The originator may respond by selecting who is to pay for the message by pressing an appropriate key on touchpad 82, or in any other suitable manner. For example, the originator could either press the ‘1’ key to indicate that the originator is to be charged for the message, or press the ‘2’ key to indicate that the recipient is to be charged for the message. Unit 60 receives the originator's selected indicator, whereupon VRU 110 converts the DTMF signal corresponding to the originator's selection into readable computer data. The converted DTMF signal is then forwarded to server 50.

Based on the received indicator, server 10 allocates charges associated with the message to the originator or recipient. Specifically, if charges are allocated to the originator (i.e. the originator is to pay for the message), as determined in step S604, server 10 preferably determines if the originator has enough money or credit left in a pre-paid account in step S606. Specifically, server 50 checks if the balance stored in field 290 of record 280 (FIG. 2D) associated with the originator is larger than zero (0). If not server 10 may optionally initiates a fund request sequence in step S608. During this fund request sequence, the originator may be prompted for payment information by VRU 110 of server 10. Payment information could take the form of credit card information that could be entered by the originator by way of touchpad 84 and stored and processed by server 10. Server 10, in turn, may verify the payment information and increment the contents of field 290, replenishing the account balance with an amount that has been agreed upon in advance by the originator. Alternatively, the originator could be redirected to a human operator of server 10. The human operator may in turn query the originator for payment information and then manually update the originator's account balance stored in field 290. Conveniently, as the balance stored in field 290 is only checked at this time, a user may send messages that are not pre-paid without having money in his or her account.

Once there is enough credit in the originator's account, server 50 adds an identifier to the control information associated with an about to be generated message, stored in field 276 of file 234 (FIG. 2C—corresponding to file 236 where the message the originator is to compose will be stored) in step S610. This identifier indicates that the message has been paid for. In addition, in step S612 server 50 calculates the cost of the message and updates field 290 of the record 280 associated with the originator in accounts database 56, by subtracting the calculated cost from the balance stored in field 290 of the originator's record 280. The cost may be calculated in any number of ways. It may, for example, be based on the duration of the message. Alternatively, a flat fee may be associated with each message.

If the originator does not wish to pay for the message, charges are allocated to the recipient. An indicator of the originator's choice is also determined in step S602, server 50 adds an identifier to the control information associated with an about to be generated message, stored in field 276 of file 234 (FIG. 2C—corresponding to file 236 where the message the originator is to compose will be stored) in step S614 signifying the message has not yet been paid for. Thereafter steps S616 and onward are performed.

After step S612 or S614, the originator is prompted to input an actual message in step S616. As well, the message originator may be prompted to input message control information that could include an indicator of urgency, or destination for the message. The message and control information may be received at message exchange server 10 in step S618.

Specifically, the originator speaks the to-be recorded message at telephone 80. The originator may identify the message recipient by replying to a greeting or by entering an identification number associated with the recipient. The user may enter the identifying information by pressing suitable keys on touchpad 82. Other control information, such as the urgency of the message, may also be entered by the originator through touchpad 82 when prompted by unit 60. Of course, the control information is received in the form of DTMF signals. The DTMF signals corresponding to the originator's selections are then converted into computer readable signals by VRU 110. Once the originator has sent all the control information, the originator preferably starts recording the actual personal message that is to be sent. Since the message the originator is recording arrives at unit 60 as an analog signal, the A/D converter of VRU 110 may convert the analog signal into a digital signal which can then be converted into a computer readable sound format. The processed message and the control information are then all forwarded to server 50.

Subsequently, in step S620 server 50 stores the data associated with the sent message in directory structure 54 in a directory 230 associated with the identified recipient. Server 50 preferably stores this data in a suitable sound data format. In addition, server 50 preferably stores the message control information, including the indication whether the originator has paid for the message or whether the recipient is to pay for the message, in an associated file 234.

FIG. 7 illustrates exemplary steps performed by message exchange server 10 to allow a recipient, by way of an example telephone 84, to retrieve (i.e. listen or the like) messages sent by others, in response to choosing to do so in step S402 (FIG. 4). Specifically, in step S702, server 50 receives a user's request to check unchecked messages. If a password is required in order to authenticate the identity of the person accessing stored messages, server 50 may at this point check a received password against the recipient's unique password stored in index file 232. Next, in step S704, server 50 checks whether the recipient has any unchecked messages stored at server 50. This may be done for example, by accessing the message checked field 274 of the control information files stored in directory structure 54 in a directory 230 associated with the recipient in directory structure 54, and determining which of the messages have not been checked. If there are no such messages, steps S700 are completed and the user is returned to step S402 and may perform some other operation.

If there is at least one unchecked message in directory 230 associated with the recipient then, in step S706 server 50 accesses the first unchecked message in directory 230 by locating a message file 236 corresponding to this message. In step S708 server 50 preferably determines whether the message has been paid for by checking an indicator in an associated control information file 234 corresponding to the first unchecked message that indicates whether the originator who sent the message has accepted the charge for the message. If the originator has paid for the message, then in step S718 server 50 preferably retrieves and processes the message, and sends it to the recipient. The message processing includes the conversion of the voice data into speech signals using VRU 110. The message is then sent to the recipient at telephone 84 by way of PSTN 70. In step S720, the originator may optionally be notified that the message has been checked. Moreover, in step S722, the recipient is given the opportunity to send a reply. If the recipient wishes to reply, steps S602 and onward are performed.

If, on the other hand, the message has not been paid for as determined in step S708, message exchange server 10 notifies the recipient in step S710 that the message has not been paid for, and requests the recipient to provide input specifying whether the recipient wishes to accept the charge for the message. Optionally, message exchange server 10 may reveal the identity of the message originator, possibly by sending some of the originator's personal details contained in the record 200 associated with the originator.

Message exchange server 10 receives the recipient's input in step S712. If the recipient has agreed to accept the charge for the message, as determined in step S714, server 10 next determines in step S730 if the recipient has enough money or credit left in the recipient's pre-paid account. Specifically, server 50 checks if the balance stored in field 290 of record 280 associated with the recipient is larger than zero (0). If there is not enough credit or funds in the recipient's balance, server 10 optionally initiates a fund request sequence in step S732. This sequence may be similar to that described with reference to step S608 (FIG. 6) and obtains pre-payment of an agreed-upon amount from a user. This amount may be accounted for in field 290 of an associated record 280 for the user.

Conveniently, as should now be appreciated, server 10 does not require that a user provide any pre-payment until that user wishes to send a prepaid message, or receive a message that must be paid-for. Conveniently, paidup amounts for any user as accounted for in field 290 of an associated record 280, may be used to send pre-paid message or receive unpaid messages. Alternatively, server 10 could be modified so that each user would be billed after use. As such, a total of accrued charges could be maintained, and billed periodically.

Subsequently, in step S734, charges associated with the to-be received message may be calculated, and deducted from field 290 of the record 280 associated with the recipient. Again, charges associated with a message may be calculated in any number of ways, including the message duration, or the like. The message is then provided to the recipient in step S718.

If the recipient declines to accept the charge, message exchange server 10 in step S724 does not note the message as checked, and thereby effectively leaves the message at server 50, and returns to step S704 where it determines if there are any other unchecked messages for the recipient. Optionally, in step S724, a message may be formed by message exchange server 10 and sent to the message originator advising the originator that the recipient has chosen not to assume the charges for the message. This message could be provided to the originator as a notification message, stored within the originator's mailbox as a pre-paid message. It will be appreciated that, alternatively, message exchange server 10 may in step S724 delete the message, or otherwise modify the message.

After the recipient finishes checking all the unchecked messages, the recipient may subsequently respond to one or all of the messages. Message exchange server 10 may then execute the steps illustrated in FIG. 6, as described above.

Conveniently, after a first user establishes contact with a second user, the first and second users may exchange sequential messages as described with reference to FIGS. 6 and 7. Conveniently, the first and second users may apportion costs between each other. The first user, acting as message originator, may initially decide who is to pay for the initial message. The second user, acting as originator may then decide who is to pay for the second message. Who bears the costs associated with the third, and each subsequently exchanged message may be decided by the originator of each message, and may thus be fairly apportioned between the first and second user, or be borne largely or completely by a single user.

Steps performed at server 10 to allow a user to access and use server 10 to join a conference/chat room of two or more users, and potentially initiate a one-on-one communication with one of these users exemplary of an embodiment of the present invention are more particularly illustrated in FIGS. 8-13. After logging in and upon selecting to enter a conference or chat, as determined in step S402 (FIG. 4), the user is said to metaphorically enter the chat room. Again, a user may register anonymously, and thus join a chat room anonymously. As a consequence of choosing to enter the chat room, server 10 under software control sets flag 229 of record 200 associated with the user to signify that the user is part of the chat in step S802. Once in the chat room, the user may now browse the temporary greetings of others currently part of the conference/chat. For the purposes of illustration, a user at telephone 80 (FIG. 1) will be referred to a “browsing” user. Steps detailed in FIGS. 8-13, however, are independently performed for each user.

Effectively, as will become apparent, users in the chat may communicate with each other by exchanging messages that are received almost immediately, thereby allowing near-real time communication of users.

Thus, in step S804 server 10 may provide the browsing user with a “Welcome” prompt providing the browsing user with a brief description of the chat room. To effect this, appropriate voice response segments stored in memory 140 may be converted into speech signals and sent to the user at telephone 80 via PSTN 70.

As well, in step S804 unit 60 provides the example browsing user a voice sequence that prompts the user to record a temporary personal greeting. The temporary greeting uttered by the user at telephone 80 may be converted to a suitable format and stored in field 226 of record 200, associated with that user in step S806. Prior to storage, the greeting may be screened by an operator of server 10 to ensure that its content is appropriate and not offensive. If inappropriate, the greeting may be rejected and steps S804-S806 may be repeated.

In step S808 server 10 prompts the browsing user to indicate whether he/she wishes to pay for the chat room service or whether the user wishes to use the service for free. The browsing user makes a selection by pressing the appropriate DTMF keys on touchpad 82 of telephone 80. Thus, a user who paid for the service during one session may use the chat room service for free during a subsequent session.

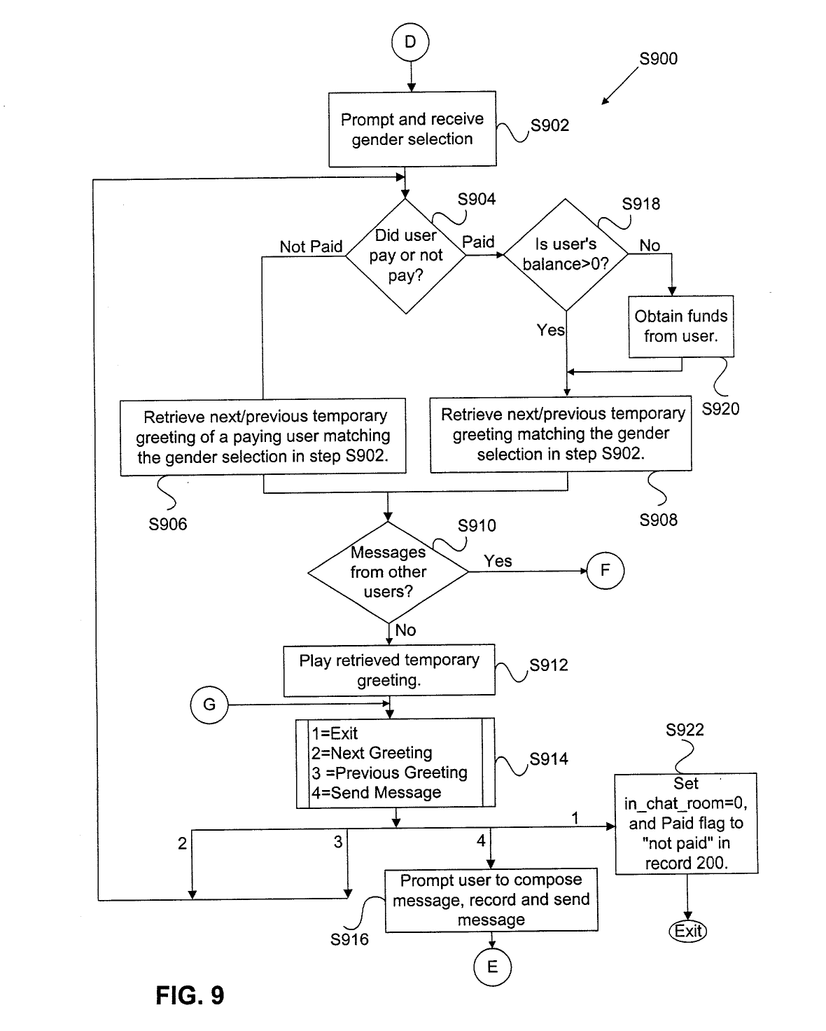

If a user decides not to pay for the chat room service, as determined in step S808, server 50 modifies the paid/not-paid field 228 of record 200 in step S816 associated with the user to indicate that the user has elected to use the service for free. Server 50 then proceeds to perform steps S900 illustrated in FIG. 9. As will become apparent, as the browsing user is not willing to pay for the service, his access to the service and other users is limited or restricted.

If, however, server 50 determines in step S808 that the user has chosen to pay for the service, server 50 proceeds to determine if any funds are associated with the browsing user in step S810. If not, server 10 prompts the user to replenish funds attributed to the user in step S812, as for example described in relation to steps S606-S608, detailed in FIG. 6. Next, in step S814 flag 228 is set indicating that the user is paying. Thereafter steps S900 (FIG. 9) are performed.

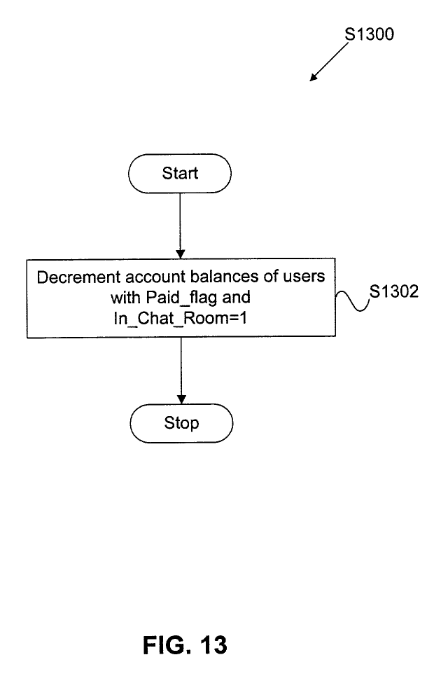

If and once the flag in field 228 is set, the browsing user's account balance is periodically decremented, so that a paying user effectively pays for time spent in the chat room. Steps SI 302 illustrated in FIG. 13 are performed by server 10 periodically at a defined interval, to debit the accounts of all users currently in the chat room for whom an associated pay flag is set. Step SI 302 may, for example, be performed as a result of a periodically occurring interrupt, invoking the execution of step SI 302 by server 10.

Once steps S800 have been performed the browsing user is prompted by server 10 to provide a gender selection, indicating whether the browsing user would like to browse the personal greeting of males or females in step S902 (FIG. 9).

Optionally, at this point server 50 may provide an audible message to the browsing user indicating the total number of other users currently in the chat room, matching the user's search criteria. This may be effected by querying database 54 for the number of records matching the browsing user's gender selection that are currently in the chat room and that have paid and not-paid for use of the chat room service. As will become apparent, users who pay for the service are provided access to all users matching the user's gender preference, that are currently in the chat room. Users who do not pay for the service are restricted in the use of the service and are only entitled to access to those that pay, and are prevented from making contact with users that do not pay. Thus, by knowing the number of paying and non-paying users matching the browsing user's preference, the browsing user may be persuaded to re-enter the chat room as a paying user.

In any event, next, in steps S906 or S908, server 10 retrieves temporary greetings of others currently in the chat room (by examining field 229 for other users) from field 226 associated with other users, matching the browsing user's gender preference and corresponding to the browsing user's payment option as determined in step S904. If, the browsing user has paid for the current chat room and is therefore entitled to browse all temporary greetings of users in the chat room, server 10 next checks in step S918 whether the browsing user has credit left in the user's corresponding account record. Specifically, server 50 checks if the balance stored in field 290 of the record 280 associated with the browsing user is larger than zero (0). If not, server 10 may request additional funds in step S920, in a manner identical to steps S606-S608 (FIG. 6). Once there is credit in the browsing user's account balance, server 10 proceeds to step S908 to retrieve temporary greeting from field 208 of the next or previous user matching the browsing user's preference. This greeting may be presented to the browsing user in step S912.

Optionally, server 50 may first verify (not specifically illustrated in FIG. 9) that at least one user meeting the search and access criteria of the browsing user is currently in the chat room. If not, server 10 may play an appropriate message and return to step S402.

However, prior to presenting any retrieved temporary greeting, server 10 determines in step S910 if any messages from other users have been sent to the browsing user. That is, as multiple users are concurrently on-line in the “chat room” they may send messages to each other and ultimately establish a live one-on-one connection.

Messages to be exchanged during a chat session may be stored in a directory structure (not specifically illustrated) similar to directory structure 230, or in a suitable data structure, stored within directory structure 54 (FIG. 1). Each message within the data/directory structure includes an identifier of the message originator and recipient. In step S910, this data/directory structure may be queried for messages destined for the browsing the user.

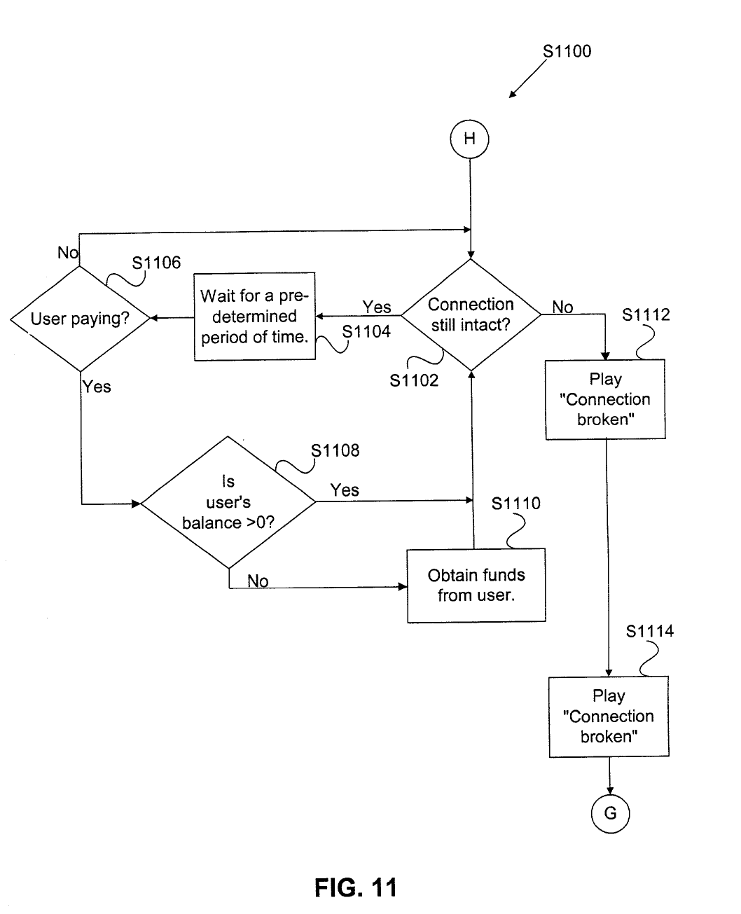

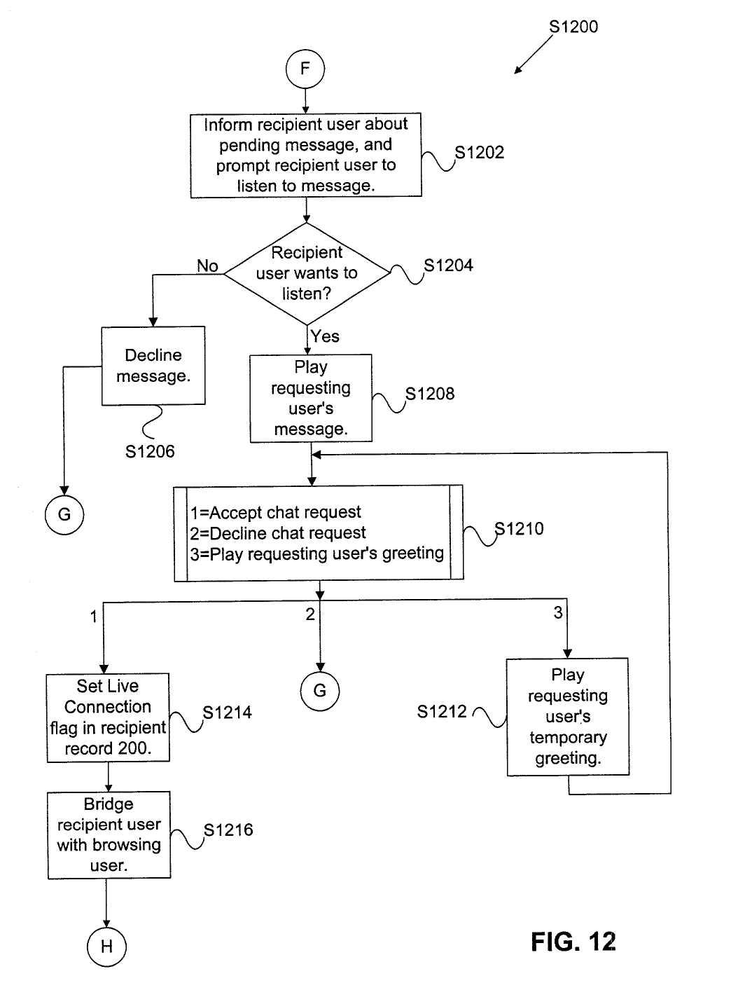

Specifically, if a message is waiting, steps S1200 in FIG. 12 are performed. That is, in step S1202 the browsing user is advised of the pending message, and given the option to listen to the pending message. If the browsing user does not wish to listen, as determined in step S1204, a “decline message” may be sent to the message originator in step S1206. Thereafter, step S914 and onward are performed, allowing the browsing user to continue browsing messages. If the browsing user wishes to listen to the message, as determined in step S1204, the message is played in step S1208. At the conclusion of the played message, the browsing user is given the options of accepting or declining any chat invitation associated with the message in step S1210. A well, the user is given the option of replaying the message originator's temporary greeting in step S1210. If the browsing user declines any chat invitation, a suitable message may be generated and provided to the requesting user, and steps S914 and onward are performed. If the user wishes to listen to the originator's greeting it is replayed in step S1212 and step S1210 is repeated. In the event the browsing user wishes to establish a live one-on-one connection with the message originator, calls associated with the browsing user and the message originator are bridged in step S1216. In step S1214 flag 227 of the browsing user is set, indicating that the browsing user is engaged in a live one-on-one conversation. Thereafter step S1100 detailed in FIG. 11 are performed to monitor the bridged call.

If no messages for the browsing user are waiting, and the temporary greeting of a potential recipient user is either played for the browsing user, or skipped, server 10 will provide a menu of the possible follow-up actions available to the browsing user in step S914. Preferably, the options include exiting; accessing the next personal greeting record matching the user's search/access criteria; accessing the previous greeting record; sending a message to a user, including a possible request to initiate a one-on-one chat; and exiting to the main menu.

If the browsing user chooses to exit to the main menu, server 10 under software control sets flag 228 and 229 in step S922 signifying the user is no longer in the chat room and not paying and proceeds to execute steps S400 and onward illustrated in FIG. 4. Conveniently, any message for the browsing user within the directory/data structure used to exchange chat messages may deleted upon exiting. If the browsing user decides to advance to the next or previous message, steps S904 and onward are repeated for the next or previous message, respectively.

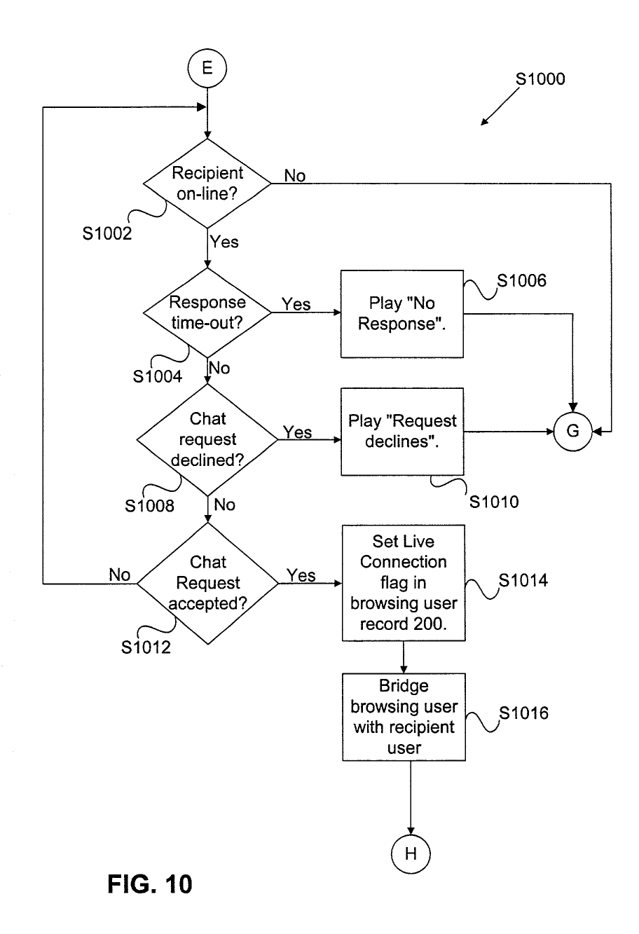

If the browsing user wishes to request a live one-on-one connection with the recipient user associated with the replayed temporary greeting, server 10 proceeds to record a message in step S916. A recorded message including originator and recipient identifiers may be stored in the above described data structure used for the exchange of chat room messages. Thereafter steps S1000 illustrated in FIG. 10 are performed to await the recipient user's response to the invitation.

As illustrated in FIG. 10, in step S1002 server 10 first assesses whether the recipient user is still in the chat room by checking field 229 of record 200 of the recipient user. If not, steps S914 and onward are again repeated. If, so server 10 assess whether a response has been received within a suitable “time out” period in step S1004. If none is received within the time-out period, a prompt indicating “No response” may be played in step S1006 and steps S914 and onward are repeated. If the request for a chat is declined, as determined in step S1008, an appropriate prompt may be provided to the browsing user and steps S914 and onward are repeated. If the chat request is accepted as determined in step S1012, the PSTN connection between the browsing user and server 10 and the PSTN connection between the recipient user and server 10 is bridged in step S1016. This may be accomplished by bridging the PSTN lines at server 10 using the VRUs associated with these lines in a manner understood by those of ordinary skill. The two users may then speak to each other in real time. Conveniently, neither user needs to reveal his/her identity. Before bridging, flag 227 of the browsing user is set in step S1014.

Server 10, executing similar steps for the recipient user, on the other hand executes steps S1200 for the recipient user in response to the browsing user dispatching a message for the recipient user, presenting the recipient user with the message. Again, a response is solicited in steps S1204-S1216.

Once the live chat connection between the two users is established, the browsing and recipient user can converse freely for as long as they wish. As long as the two users are chatting, server 10 continues to monitor whether the both users are still connected, and that the paying user or users have sufficient funds. Steps S1100 are thus performed, for both the browsing and recipient users.

In steps S1102-S1104 server 10 periodically examines whether the other user is still connected by examining field 227 of record 200 associated with the other user. If server 10 determines that the other user is no longer participating in the live connection, server 10 in step S1112 sends to the remaining user the voice sequence “Connection broken”. Thereafter, server 10 returns to step S914 and prompts the remaining user for the next action it wishes to take.

While the connection is intact, server 10 assesses if paying users have sufficient funds in steps S1106-1110. This is accomplished by server 10 checking a paying (as determined in step S1106) user's account balance in step S1108. If funds in the account become depleted, more funds are requested in step S1110.

Either user may terminate the live chat connection at any time by pressing a suitable DTMF key, for example, the ‘#’ key. This tone may be monitored in steps S1100 (not specifically illustrated), and the connection can be broken. As a consequence, server 10 may allows the user to resume his/her previous activity by repeating steps S914, and onward. Additionally, field 227 associated with the user may be set to indicate the user is no longer engaged in a live connection in step S1114.

As should now be apparent, if the example user uses the chat room service free of charge, he/she can only send personal messages and request live connections only to those users who are currently paying for the chat room service. Similarly, the example user, under these circumstances, may only receive personal messages from users who are paying for the chat room service. In this way, multiple users cannot use server 10 to receive chat services for free. If the example user chooses to pay for the service, the example user may send and receive personal messages from all the users in the chat room. As well, the example user may try to establish a live connection with all other users in the chat room.

As will also be appreciated, while the organization of hardware and software components, databases and directory structure have been illustrated as clearly delineated, a person skilled in the art will appreciate that this delineation and organization is somewhat arbitrary. Numerous other arrangements of hardware, software and data are possible. For example, database server 50 and IVR unit 60 could be combined into a single unit whereby that unit would have similar components as those described in relation to server 50 and IVR unit 60. Similarly, databases 52 and 56 could be organized in numerous ways, using relational or object oriented structures. Similarly, data stored in such databases could be stored in numerous equivalent ways. Similarly, directory structure 54 could be replaced by any number of equivalent data organizations, including, for example, one or more databases. Furthermore, the server as illustrated may also be interconnected to a packet switched data network, such as the public Internet, thereby allowing users to also access the server using interconnected computing devices.

Similarly, as will be appreciated, the described method of allowing some non-paying users restricted access and use of a chat room serve is not limited to use in dating service systems, but in fact can be used in any system that utilizes a chat room server.

It will be further understood that the invention is not limited to the embodiments described herein which are merely illustrative of a preferred embodiment of carrying out the invention, and which is susceptible to modification of form, arrangement of parts, steps, details and order of operation. The invention, rather, is intended to encompass all such modification within its scope, as defined by the claims.

What is claimed is:

1. At an apparatus facilitating exchange of stored voice messages, a method of allocating charges associated with sending messages from a message originator to a recipient, comprising:
receiving from said originator an indicator of whether a charge for a voice message is to be borne by said originator or by said recipient;
allocating said charge to one of said originator and said recipient, based on said indicator.

2. The method of claim 1, further comprising receiving said voice message from said originator.

3. The method of claim 2, further comprising billing said charge based on said allocating.

4. The method of claim 3, wherein said billing comprises debiting a pre-paid account by an amount equal to said charge.

5. The method of claim 1, further comprising
if said charge is allocated to said recipient, receiving from said recipient an input indicating if said recipient will accept said charge.

6. The method of claim 5, further comprising billing said charge to said recipient, only if said input indicates said recipient has agreed to assume said charge.

7. The method of claim 2, further comprising prompting said recipient to accept said message and assume said charge, if said charge has been allocated to said recipient.

8. The method of claim 7, further comprising advising said originator if said recipient declines to assume said charge.

9. The method of claim 1 wherein said apparatus comprises a personal introduction system.

10. The method of claim 9, wherein said message is composed in response to browsing a plurality of personal greetings stored at said system.

11. The method of claim 1, further comprising calculating said charge.

12. The method of claim 1, wherein said indicator is received by way of telephone.

13. The method of claim 12, wherein said indicator comprises a specified DTMF tone associated with said message.

14. An apparatus facilitating exchange of voice messages, comprising:
a network interface interconnecting said apparatus to a communications network, to allow a message originator to dispatch a voice message to a recipient;
a processor in communication with said network interface;
memory for storing voice messages to be exchanged,
said memory storing program instructions, adapting said apparatus to:
receive from said originator an indicator of whether a charge for a voice message is to be borne by said originator or by said recipient;
allocate said charge to one of said originator and said recipient, based on said indicator.

15. A computer readable medium, storing computer executable instructions that when loaded at a message exchange server, used to exchange messages between a message originator and a recipient, adapt said server to:
receive from said originator an indicator of whether a charge for a stored message is to be borne by said originator or by said recipient;
allocate said charge to one of said originator and said recipient, based on said indicator.

16. A method of exchanging a plurality of messages between a first and second user, said method comprising:
receiving from an originator of each of said plurality of messages an indicator of whether a charge associated with said each of said plurality of messages is to be borne by said first user or by said second user;
allocating an associated charge for said each of said plurality of messages to one of said first and second user, based on said indicator;
repeating said receiving and said allocating for each of said plurality of messages.

17. A method of operating a device providing a service allowing a plurality of users to communicate with each other, comprising:
for each of said plurality of users determining if said each of said plurality of users wishes to pay for use of said service, and thereby identifying each of said users as a paying user or a non-paying user;
allowing paying users to communicate with all of said plurality of users;
restricting non-paying users from communicating with other non-paying users.

18. The method of claim 17, wherein said device permits bridging of telephone calls between said plurality of users.

19. The method of claim 17, wherein said device permits said users to exchange messages with each other in near real-time.

20. The method of claim 18, wherein said allowing comprises allowing paying users to bridge telephone calls with all other of said plurality of users, and
wherein said restricting comprises preventing non-paying users from bridging telephone calls with other non-paying users.

21. The method of claim 17, wherein said device comprises a telephone interface and a storage medium, and wherein said method comprises exchanging saved messages between said users.

22. The method of claim 19, further comprising calculating costs of said service for each of said paying users, based on time each of said paying users uses said service.

23.A method of operating a message exchange device comprising:
storing greetings originating with each of a plurality of users using said message exchange device;
obtaining from each of said plurality of users an indicator of whether that user wishes to pay to use said message exchange server, thereby classifying each of said plurality of users as a paying or non-paying user;
allowing paying users access to all of said stored greetings;
allowing non-paying users access to only those greetings originating with paying users.

24. The method of claim 23, wherein said greetings comprise voice messages and said allowing paying users comprises allowing paying users to listen to all of said stored greetings.

25. The method of claim 23, further comprising charging each paying user based on time spent by that paying user using said server.

26. The method of claim 23, wherein each of said plurality of users is currently using said message exchange device, and further comprising allowing users to exchange messages in near real-time.

27. A message exchange server comprising computer readable memory storing
a plurality of messages, each of said messages associated with a user of said server;
a plurality of indicators, each identifying whether a user pays to use said message exchange server and is thereby a paying user, or whether a user does not pay to use said service and is thereby a non-paying user;
software, adapting said server to
allow those paying users access to all of said plurality of messages;
allow non-paying users access to only those messages associated with paying users.

28. The server of claim 27, wherein said messages comprise digitized voice messages.

29. The server of claim 28, wherein said computer readable memory further stores an amount representative of prepayment of users paying for said service.

30. A computer readable medium, storing computer executable instructions that when loaded at a message exchange server, used to exchange messages between users, to:
store greetings originating with each of a plurality of users using said message exchange device;
obtain from each of said plurality of users an indicator of whether that user wishes to pay to use said message exchange server, thereby classifying each of said plurality of users as a paying or non-paying user;
allow paying users access to all of said stored greetings;
allow non-paying users access to only those greetings originating with paying users.
